(19) United States
(12) Patent Application Publication
(10) Pub. No.: US 2021/0034797 A1
(43) Pub. Date: Feb. 4, 2021

(54) METHOD FOR TESTING A VEHICLE

(71) Applicant: Robert Bosch GmbH, Stuttgart (DE)

(72) Inventor: Michael Schmitt, Eberstadt (DE)

(21) Appl. No.: 16/885,673

(22) Filed: May 28, 2020

(30) Foreign Application Priority Data
Jul. 29, 2019 (DE) 102019211241.2

(51) Int. Cl. G06F 30/20; G06F 30/15

(52) U.S. Cl. CPC G06F 30/20; G06F 2119/02; G06F 30/15

(57) ABSTRACT

A computer-implemented method for testing a vehicle. The method includes: a first digital model of the vehicle is analyzed in a first driving simulation with regard to whether a safety-related requirement is satisfied, at least one second digital model of the vehicle is analyzed in at least one second driving simulation with regard to whether the safety-related requirement is satisfied, the at least one second digital model differing from the first digital model owing to a parameter variation which represents a structural change of the vehicle, depending on results of the first and the at least one second simulation, boundaries within which a structural change is able to be made or boundaries within which the parameters are able to be varied are determined, in order that the safety-related requirement remains satisfied.

### CROSS REFERENCE

The present application claims the benefit under 35 U.S.C. § 119 of German Patent Application No. DE 102019211241.2 filed on Jul. 29, 2019, which is expressly incorporated herein by reference in its entirety.

### FIELD

The present invention relates to computer-implemented methods for testing a vehicle as well as computer programs and test systems created for that purpose.

### BACKGROUND INFORMATION

Due to safety regulations, separate product releases are implemented for various types of vehicles that differ from each other, e.g., owing to different designs, equipment or motorizations. To that end, all necessary tests including driving maneuvers may be carried out for each vehicle variant. Vehicles deviating from the basic types of released vehicle variants may likewise be released based on expert assessment, for example. In the case of commercial vehicles, the vehicle may be altered by body structures and built-in components, for instance, without a complete product release having to be carried out for this.

German Patent Application Nos. DE 20 2018 106888, DE 10 2019 209538 and DE 10 2019 209539 describe methods for simulative tests on a system.

### SUMMARY

In accordance with the present invention, a method is provided for testing a vehicle for a safety-related requirement.

In so doing, a first digital model of the vehicle is analyzed in a first driving simulation with regard to whether a safety-related requirement is satisfied. At least one second digital model of the vehicle is analyzed in at least one second driving simulation with regard to whether the safety-related requirement is satisfied, the at least one second digital model differing from the first digital model owing to a parameter variation which represents a structural change of the vehicle. Depending on results of the first and the at least one second simulation, boundaries within which a structural change may be made or boundaries within which the parameters may be varied are determined, in order that the safety-related requirement remains satisfied.

The first and the second driving simulation may be conducted concurrently or sequentially. The first and further digital models may also be tested by continuous parameter variation in one joint simulation, thus, the first driving simulation and second driving simulation(s) described are carried out as one simulation.

Using the example tests, the safety of a vehicle, even with later structural changes, may already be ensured during development. Approvals or product releases which also take later structural changes into account may be supported in dependence on such tests, as well, thereby likewise contributing to the safety of vehicles. In particular, the problem is also solved that, owing to additional later vehicle body structures and vehicle modifications, e.g., by third-party providers, as well, vehicle functions will be operated in untested areas.

Accordingly, in one preferred development, the parameter variation represents altered equipment, an additional body structure or modification or attachment, a change in the wheels, a retrofitting or altered equipment.

In particular, for safety-related sub-systems of a vehicle such as ESP or ASB, for instance, boundary values for structural changes may be derived, within which they are still able to operate perfectly in terms of the legal or specified requirements. Accordingly, in one preferred development in accordance with the present invention, the safety-related requirement includes a requirement with respect to a brake system, a steering system or a drive system of the vehicle. In further preferred refinements, the safety-related requirement includes a requirement with respect to operating dynamics, handling performance or driving stability of the vehicle or with respect to stability of controllers of the vehicle.

In one preferred development of the present invention, the parameter variation represents an altered distribution of mass, an altered location of the center of mass and/or an altered weight of the vehicle. These quantities are especially easy to vary in models and cover a large part of the influence of structural changes on the safety of vehicles, therefore are particularly well-suited for the methods proposed.

In one especially preferred development of the present invention, the boundaries are determined in such a way that the safety-related requirement remains satisfied with a safety corridor, in particular, allowing for uncertainties in the models. The reliability of the methods described is increased by this measure.

Below, specific embodiments of the present invention are explained in greater detail with reference to the figure. FIG. 1 shows schematically the exemplary functional sequence of a method for testing a vehicle.

### BRIEF DESCRIPTION OF THE DRAWING

FIG. 1 shows schematically an exemplary functional sequence of a computer-implemented method to test a vehicle for a safety-related requirement, in accordance with the present invention.

### DETAILED DESCRIPTION OF EXAMPLE EMBODIMENTS

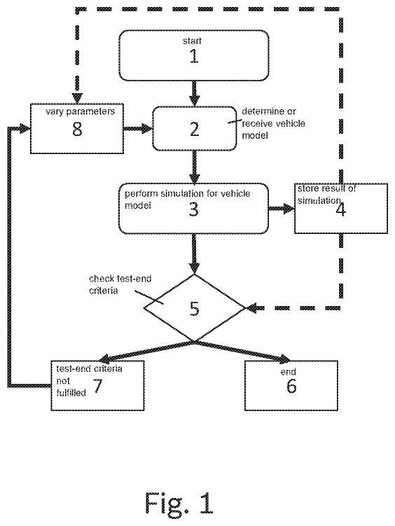

FIG. 1 shows schematically an exemplary functional sequence of a computer-implemented method to test a vehicle for a safety-related requirement, in accordance with the present invention.

The method is started in a step 1. In a step 2, a vehicle model is determined or received, which forms the basis of the following simulation step. In a first passage through the loop, a vehicle model is specifically utilized here which describes the vehicle in a basic specification. In this case, the model may be a digital twin of the real vehicle and be in the form of a simulation model. At the same time, preferably the simulation model is sufficiently qualified, so as later to be able to derive desired evidence concerning product safety and possibly also product releases from the results of the corresponding simulations.

In following step 3, a simulation is performed for the vehicle model employed. In so doing, in the simulation, driving maneuvers may be simulated with which certain safety-related requirements for the vehicle are able to be checked. For this, at least one requirement is received in machine-readable form.

For example, such a requirement could include a requirement with respect to a steering system of the vehicle, e.g., a maximum reaction time of a steering system after an automatic steering request or a maximum braking distance for an automatic emergency braking system, or requirements with respect to an ABS system or ESP system of the vehicle, in each instance under specific conditions. As a requirement, it may also be checked whether particular controllers in the vehicle exhibit a certain, especially a stable behavior. Suitable simulation conditions, for instance, driving maneuvers are determined for the requirement, e.g., as input quantities for the simulation. In so doing, such a generation of input quantities may be carried out or assisted using optimization methods such as search based testing.

Based on at least one observed or received output quantity of the simulation, it is now checked whether and possibly to what extent the requirement is satisfied in a specific simulated driving situation, or lies in a desired parameter range for the output quantity in line with previously defined boundaries from the requirement.

The result of the simulation is stored or output in following step 4. Specifically, in this instance, the stored or output information may include whether, how well and under what conditions the requirement was met as well as for which model parameters it was met, that is, for which model utilized in step 2.

In optional step 5 following step 3, a test-end criterion may be checked. As a result, the test may be ended and therefore no further loops are executed if the test-end criterion is fulfilled. For example, such a test-end criterion may be defined subject to a length of time of the test or a number of executed loops (i.e., simulations carried out for different models). A test-end criterion may also be dependent on which parameter space for changes of the starting model is already covered (see step 8) or to what extent a desired test coverage is already achieved. The result of the previous simulation(s) stored or output in step 4 may also be consulted for this purpose.

If the test-end criterion is fulfilled, step 5 branches to step 6. The test is ended accordingly.

If the test-end criterion is not fulfilled, step 5 branches to step 7, and the test is continued accordingly with step 8.

In step 8, parameters are now varied, starting from a model already considered, particularly a vehicle model that describes a basic specification of the vehicle, or starting from a model already modified in a previous loop with parameter variation. In particular, the parameters are varied so as, based on the further simulation, to be able to make statements not only about compliance with the requirement by the vehicle according to the basic specification, but also statements about compliance with the requirement by vehicle properties possibly deviating from the basic specification.

In this context, the parameter variation relates to parameters which correspond to a structural change of the vehicle, especially due to modifications, body structures or attachments as are typical, e.g., for commercial vehicles such as platform trucks, panel vans or small delivery trucks. Altered or exchanged wheels, wheel rims, tires or otherwise altered equipment as well as retrofittings may also be represented. For instance, distribution of mass, location of the center of mass or a total weight of the vehicle may be varied in the model.

In particular, the parameter variation may be accomplished through previously defined distributions or by optimization of the variation with direct evaluation of the simulation runs already carried out, e.g., with the aid of a cost function. Preferably, the parameter variation may be implemented depending on simulation results stored or output in step 4.

Step 8 is now followed again by steps 2 through 4. In this instance, the model after parameter variation is now utilized for the simulation in this run-through, and it is checked in the simulation whether and possibly how well the requirement is met for this model.

Thus, after several run-throughs, evidence may be obtained not only about whether and how the vehicle in basic specification satisfies the requirement, but also about the boundaries within which a structural change may be made to the vehicle, without the safety-related requirement no longer being satisfied.

At the same time, preferably a safety corridor is provided, thus a distance to the boundaries, as of which the requirement is no longer met. Namely, the uncertainty of the models may thereby be taken into account.

Sets of parameters, parameter spaces or parameter ranges for which the requirement is met, or correspondingly, boundaries for structural changes to the vehicle permissible with respect to this requirement may be output as a result of the method.

The results are able to promote the safety of a vehicle already during development, but may also be used in product tests or for product releases.

What is claimed is:

1. A computer-implemented method for testing a vehicle, comprising the following steps:
analyzing a first digital model of the vehicle in a first driving simulation with regard to whether a safety-related requirement is satisfied;
analyzing at least one second digital model of the vehicle in at least one second driving simulation with regard to whether the safety-related requirement is satisfied, the at least one second digital model differing from the first digital model due to a parameter variation which represents a structural change of the vehicle; and
depending on results of the first driving simulation and the at least one second simulation, determining boundaries within which a structural change is able to be made or boundaries within which the parameter is able to be varied, in order that the safety-related requirement remains satisfied.

2. The method as recited in claim 1, wherein the parameter variation represents an altered distribution of mass of the vehicle, and/or an altered location of a center of mass of the vehicle and/or an altered weight of the vehicle.

3. The method as recited in claim 1, wherein the parameter variation represents altered equipment or an additional body structure or modification or attachment, or a change in the wheels, or retrofit equipment.

4. The method as recited in claim 1, wherein the boundaries are determined in such a way that the safety-related requirement remains satisfied with a safety corridor.

5. The method as recited in claim 1, wherein the boundaries are determined allowing for uncertainties in the first and second digital models.

6. The method as recited in claim 1, wherein the safety-related requirement includes a requirement with respect to a brake system of the vehicle, or a requirement with respect to a steering system of the vehicle, or a requirement with respect to a drive system of the vehicle.

7. The method as recited in claim 1, wherein the safety-related requirement includes a requirement with respect to operating dynamics of the vehicle, or a requirement with respect to a handling performance of the vehicle, or a requirement with respect to a driving stability of the vehicle.

8. The method as recited in claim 1, wherein the safety-related requirement includes a requirement with respect to stability of controllers of the vehicle.

9. A non-transitory machine-readable memory on which is stored a computer program for testing a vehicle, the computer program, when executed by a computer, causing the computer to perform the following steps:
analyzing a first digital model of the vehicle in a first driving simulation with regard to whether a safety-related requirement is satisfied;
analyzing at least one second digital model of the vehicle in at least one second driving simulation with regard to whether the safety-related requirement is satisfied, the at least one second digital model differing from the first digital model due to a parameter variation which represents a structural change of the vehicle; and
depending on results of the first driving simulation and the at least one second simulation, determining boundaries within which a structural change is able to be made or boundaries within which the parameter is able to be varied, in order that the safety-related requirement remains satisfied.

10. A test system for testing a vehicle, the test system configured to:
analyze a first digital model of the vehicle in a first driving simulation with regard to whether a safety-related requirement is satisfied;
analyze at least one second digital model of the vehicle in at least one second driving simulation with regard to whether the safety-related requirement is satisfied, the at least one second digital model differing from the first digital model due to a parameter variation which represents a structural change of the vehicle; and
depending on results of the first driving simulation and the at least one second simulation, determine boundaries within which a structural change is able to be made or boundaries within which the parameter is able to be varied, in order that the safety-related requirement remains satisfied.
